(19) United States
(12) Patent Application Publication
(10) Pub. No.: US 2011/0314275 A1
(43) Pub. Date: Dec. 22, 2011

(54) MANAGING ENCRYPTION KEYS

(76) Inventors: Michael Gopshtein, Yehud (IL); Eyal Kenigsberg, Dolev (IL); Guy Offer, Rehovot (IL); Nick Ioffe, Bat Yam (IL)

(21) Appl. No.: 12/821,118

(22) Filed: Jun. 22, 2010

(51) Int. Cl. H04L 29/06; H04L 9/00

(52) U.S. Cl. 713/165; 380/277

(57) ABSTRACT

Methods, apparatus, and articles of manufacture to manage encryption keys are disclosed. An example method to manage encryption keys includes obtaining data including a private key, determining that the data cannot be read according to a first format by attempting to read the data in the first format, in response to determining that the data cannot be read according to the first format, accessing the private key by reading the data according to a second format different from the first format, and converting the data from the second format to a third format.

### BACKGROUND

Network communications are often encrypted to prevent access by unauthorized sources. For example, a combination of the hypertext transfer protocol (HTTP) and the secure socket layer (SSL)/transport layer security (TLS) results in the HTTP secure (HTTPS) protocol. HTTPS creates a secure channel over an insecure network by defining procedures for communication endpoints to securely encrypt communications. When a client wants to establish a secure communication session with a server, the client requests a public key from the server for an asymmetric key algorithm. The public key is a value that is used in a mathematical algorithm to encrypt a communication that can only be decrypted using the corresponding private key. In other words, once encrypted with the public key, the communication cannot be decrypted using the public key. The public key may be combined with a digital certificate that is signed by a trusted security authority to certify the identity of the server. When the communication is received at the server, the private key is used by the server to decrypt the communication. In some systems, a handshake is performed to establish a communication session between two computing devices. The private key is used to encrypt communications in which the two computing devices agree on a symmetric key that is used for encrypting subsequent communications during the communication session. By ensuring that unauthorized parties do not get access to the private key, the server can prevent unauthorized parties from gaining access to the contents of encrypted communications. Accordingly, the private key may be stored with a password that prevents access to the private key without using the password.

### BRIEF DESCRIPTION OF THE DRAWINGS

FIG. 1 illustrates an example encryption key manager to manage private keys.

FIG. 2 is a block diagram is another implementation of an encryption key manager to manage private keys.

FIG. 3 is a block diagram of an example system that utilizes the encryption key manager of FIG. 1 or the encryption key manager of FIG. 2.

FIG. 4 is a flowchart representative of example machine readable instructions to implement encryption key manager of FIG. 1.

FIG. 5 is a flowchart representative of example machine readable instructions to implement the encryption key manager of FIG. 1.

FIG. 6 is a flowchart representative of example machine readable instructions to implement the decryption monitor of FIG. 3.

FIG. 7 is a schematic illustration of an example processor platform that may be used and/or programmed to execute the example interactions, the example processes and/or the example machine-accessible instructions of FIGS. 4-6 to implement any or all of the example methods, apparatus and/or articles of manufacture described herein.

### DETAILED DESCRIPTION

When a communication has been encrypted with a public key associated with a private key, the communication cannot be decrypted without using the private key. Accordingly, any computing device that wants to read the communication encrypted with a private key must have the private key. Furthermore, when a communication session is initiated using a private key encryption to agree on a symmetric key, the private key is needed to decrypt the communications of the handshake to determine the symmetric key. Typically, a private key is only installed on one or a small number of computing devices to prevent unauthorized access to encrypted communications. However, it is sometimes useful to provide the private key to other computing devices. In such instances, the private key can be exported from one of the computing devices on which the private key is currently stored and can be imported into the computing device on which access to encrypted messages is desired.

For example, a real user monitor (RUM) is a component of a business service management (BSM) system that monitors the operation of business computing devices and users to enable an administrator to manage the business computing system. The RUM works with a network element such as a switch to obtain copies of network communications for analysis. When the network communications are encrypted using a public key associated with a private key of, for example, a server, the communications cannot be accessed by the RUM without knowledge of the private key. An administrator of the RUM can export the private key from the server and can import the private key to the RUM to enable the RUM to decrypt and access the encrypted network communications.

There are many different formats for private key files, such as, for example distinguished encoding rules (DER) format, privacy enhanced mail (PEM) format, public key cryptography standards (PKCS) 12 (PKCS12) format, personal information exchange (PFX) format, etc. Typically, an administrator must know the format of a private key file when importing the private key file to a server or system (e.g., the RUM).

Methods, apparatus, and articles of manufacture to manage encryption keys are disclosed. The example methods, apparatus, and articles of manufacture can import a private key to a server without knowledge of the format of the file storing the private key. Accordingly, an administrator does not need to specify the format of the file storing the private key. Example implementations detect when errors occur during importing the private key and can report those errors and the error types to the administrator. In addition, example implementations can monitor a decryption process to detect errors during decryption. For example, an example implementation detects when a private key for a destination of a communication is not available. In an example implementation, the statistics are reported regarding the number of times that decryptions are successful and the number of times that each type of decryption error occurs.

While the example implementations described herein reference private keys, any type of decryption key or parameter may be used. In other words, the methods, apparatus, and articles of manufacture described herein may be used to manage any type of decryption key or parameter.

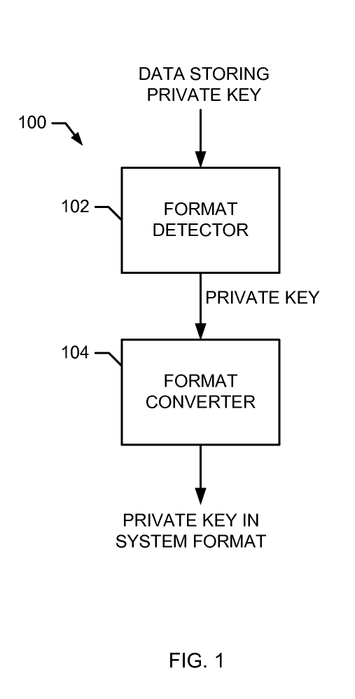

FIG. 1 illustrates an example encryption key manager 100 to manage private keys. The system 100 of the illustrated example receives files in multiple different formats containing private keys for secure communications and converts them to a system format (i.e., a single format configured for the system 100). While private keys are described herein, implementations described herein may include any type of encryption key (e.g., private key, public key, symmetric key, etc.) for any type of encryption (e.g., HTTPS, TLS, SSL, etc.). The example encryption key manager 100 includes a format detector 102 and a format converter 104.

According to the illustrated example, the example format detector 102 receives a file that is identified by a user of the encryption key manager 100 as containing a private key and a password for the private key. The format detector 102 of the illustrated example attempts to determine the format of the file and verify that the file includes the private key. The example format detector 102 detects the format of the file by attempting to access the file using the password according to formats on a list of available formats until the file is readable using one of the formats. In other words, the format detector 102 of the illustrated example iteratively attempts to access the file using each of the available formats using the password until a format for the file is detected or no further formats are available. When no further formats are available, the format detector 102 determines that the format of the file is unknown. Accordingly, a user of the encryption key manager 100 can provide a file to the format detector 102 without the need to convert the file to a particular format and without knowledge of the format of the file.

The example format detector 102 includes a list of available formats including distinguished encoding rules (DER) format, privacy enhanced mail (PEM) format, and public key cryptography standards (PKCS) 12 (PKCS12) format. The format detector 102 may additionally or alternatively use a list of formats including one or more of DER format, PEM format, PKCS12 format, any other PKCS format, personal information exchange (PFX) format, etc. Additionally, the format detector 102 of the illustrated example can receive a private key stored in a keystore such as, for example, a Java Key Store (JKS) file and can retrieve a private key from the keystore.

While the format detector 102 detects the format of an input file by iteratively trying formats for the file, any other procedure may be used to determine the file format. For example, a header of the file may be read to identify the file type, a user input may indicate the format of the file, the extension of the file may be determined to identify the file type, etc. Additionally, the private key may be provided to the format detector 102 in any manner. For example, the private key may be provided to the format detector 102 in a file, may be provided to the format detector 102 in a data stream, may be retrieved from a data store by the format detector 102, may be extracted from a bundle or grouping of data, etc.

When the format detector 102 of the illustrated example is unable to read the file, the format detector 102 provides an error message. According to the illustrated example, an error message is provided when the file is corrupted, the file is not in any of the recognized formats, the password for the file is incorrect, or the file is read but a private key is not found in the file. When the format detector 102 is able to read the file and access the private key, the format detector 102 of the illustrated example extracts the private key and sends the private key in a private key object to the format converter 104. The example private key object is an object of the security package of JAVA. Alternatively, the format detector 102 may send the private key, the file, the password, and/or an identification of the identified format to the format converter 104 in any format for accessing the file.

The format converter 104 of the illustrated example receives the private key object from the format detector 102 and converts the private key object to a system format defined for the encryption key manager 100. The format converter 104 of the illustrated example converts the private key object to an OpenSSL PEM format and stores the private key object in a memory. Alternatively, the format converter 104 may convert the private key object to any available format and store the private key object in any location.

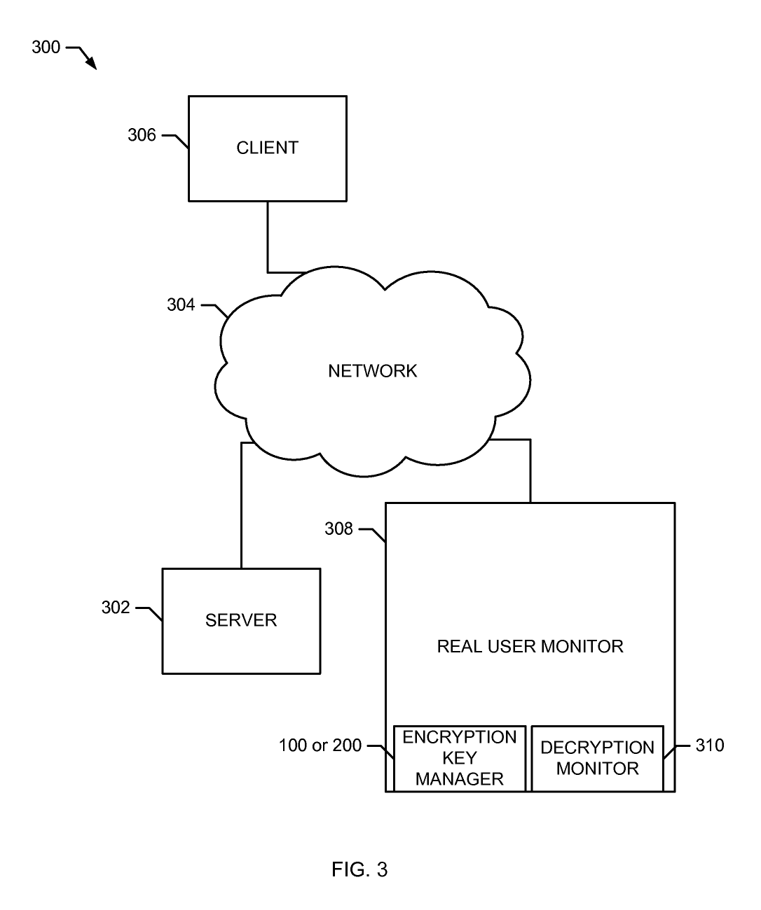

Private key object(s) stored by the format converter 104 may be used in encryption processes. For example, the encryption key manager 100 of the illustrated example, is implemented in accordance with a real user monitor (RUM) of a business service management (BSM) system as described in conjunction with FIG. 3 to enable the RUM to decrypt communications encrypted using the public key(s) corresponding to the private key(s).

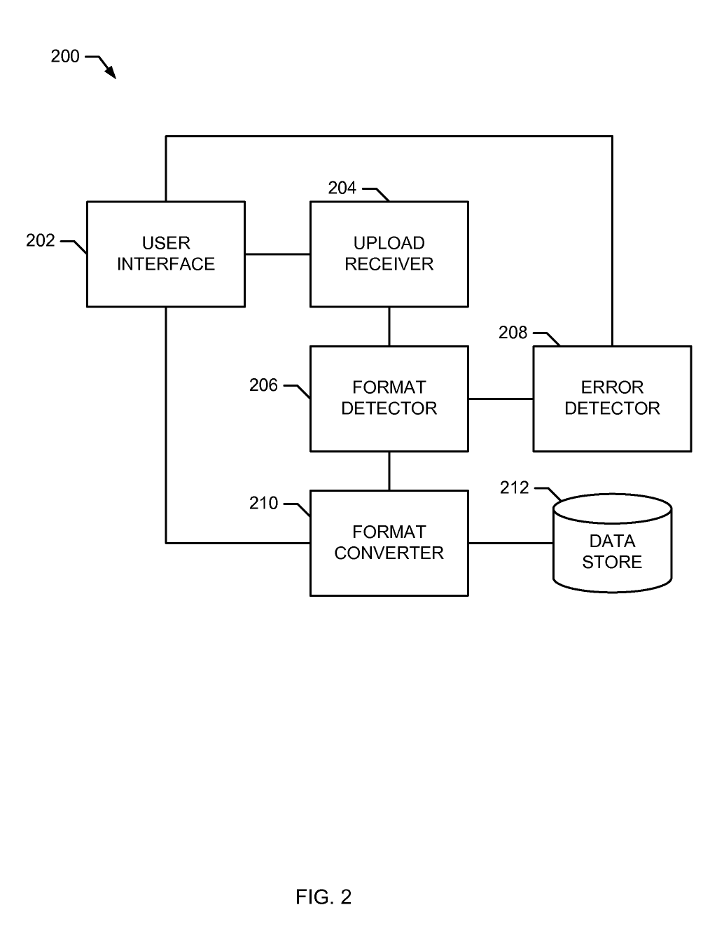

FIG. 2 is a block diagram is another implementation of an encryption key manager 200 to manage private keys. The example encryption key manager 200 includes a user interface 202, an upload receiver 204, a format detector 206, an error detector 208, a format converter 210, and a data store 212.

The user interface 202 of the illustrated example receives user input and provides feedback from the encryption key manager 200. The example system receives a user input of a file and corresponding password for processing by the system 202. According to the illustrated example, the example user interface 202 provides input field(s) for the user to specify a path in memory to the file and user input field(s) to specify the password(s). The example user interface 202 includes a file location input field and a password text field for a user to specify information for a file. In addition, the example user interface 202 includes a separate area for inputting information specifying a keystore containing a private key (i.e., a path input field for the keystore, a password for the keystore, an alias for the private key stored in the keystore, and a password for the private key stored in the keystore). The user interface 202 of the illustrated example also includes an input field for a user to specify a name for the private key that is to be used when storing the private key in the encryption key manager 200. Alternatively, any other input method and combination of inputs may be used. For example, a user may provide a link to a database including the information, may use a graphical user interface paste function to provide the file, may provide a link to a resource on the internet, may initiate and/or review the results of a search of storage locations for a private key file, etc. The user interface 202 may be any type of graphical, command line, or other interface. The inputs received from the user interface 202 are provided to the upload receiver 204.

The upload receiver 204 of the illustrated example receives the information collected by the user interface 202 and obtains the private key or keystore. According to the illustrated example, the upload receiver 204 receives the identification of the path in memory to a file containing the private key or keystore and loads the identified file into active memory for processing. Alternatively, any other process for accessing and locating the private key file(s) or other data structures may be used. The example upload receiver 204 transfers control of the file in memory to the format detector 206. In addition, the upload receiver 204 of the illustrated example sends the password(s) and/or key alias information received by the user interface 202 to the format detector 206. Alternatively, the upload receiver 204 may identify the location of the file in memory to the format detector 206 or use any other process for identifying the file to the format detector 206.

The format detector 206 of the illustrated example detects the format of the identified file as described in conjunction with the format detector 102 of FIG. 1. In particular, the example format detector 206 iteratively attempts to access the file using the received password(s) and/or key alias information according to available encoding formats until the file can be accessed using the correct encoding format. The format detector 206 may optionally store the identifying format for later use. The format detector 206 of the illustrated example automatically identifies the format of the file without a user indicating the format. Alternatively, to identify the format of the file, the format detector may read a header of the file, a user input may indicate the format of the file, the extension of the file may be determined, etc. The format detector 206 may perform only some of the functions described in conjunction with the format detector 102 of FIG. 1 and may perform other functions. Once a format for the file is detected, the format detector 206 extracts the private key object and ends the private key object to the format converter 210 of FIG. 2.

The error detector 208 of the illustrated example monitors the operation of the format detector 206 to detect and report errors in the format detection 206. While the format detector 206 is attempting to read the identified file, the example error detector 208 determines if the password supplied to the user interface 202 is incorrect by determining that the file was accessed using a particular format but the private key could not be accessed because the password was incorrect. The example error detector 208 also determines if the format detector 206 has attempted and failed to read the file using all available formats and, therefore, determines that the file is in a format that is unknown. The error detector 208 also determines if the file does not contain a private key (e.g., the file is a certificate file that doesn't include a private key) by determining that the file was accessed using a particular format but no private key was found. The error detector 208 may detect any other errors and may use any other process for detecting the errors. Once the error detector 208 of the illustrated example has detected one or more errors, the error detector 208 causes a message to be displayed on the user interface 202. Alternatively, the error detector 208 may store errors to a file, may provide an audible indication of the error, may prompt the user to correct the error (e.g., by supplying a new password), etc.

The format converter 210 receives the private key object and the identified format from the format detector 206 and converts the private key object to a system format as described in conjunction with the format converter 104 of FIG. 1. The example format converter 210 stores the converted private key object in the data store 212. The format detector 206 may perform only some of the functions described in conjunction with the format detector 102 of FIG. 1 and may perform other functions.

The data store 212 of the illustrated example stores the private key object(s) stored by the format converter 210. The data store 212 of the illustrated example is one or more files storing the private key objects. Alternatively, any other type of data storage could implement the data store 212 such as, for example, a database, a memory location, a storage device, etc.

FIG. 3 is a block diagram of an example system 300 that utilizes the encryption key manager 100 of FIG. 1 or the encryption key manager 200 of FIG. 2. The example system 300 includes a server 302, a network 304, a client 306, and a real user monitor 308.

The server 302 of the example system 302 is communicatively coupled to the client 306 and the real user monitor 308 via the network 304. The example server 302 is a webpage server that operates using the HTTP and HTTPS protocols. Alternatively, the server 302 could be any type of server that provides any type of service to the client 306. The system 300 may include any number of servers and the servers may provide any number of services. The server 302 includes an encryption system to receive, via the network 304, communications encrypted by the client 306 using a public key and to decrypt the communications using a private key corresponding to the public key. The server 302 additionally may encrypt communications using a key supplied by the client 306 and transmit the encrypted communications to the client 306 via the network 304.

The network 304 is a local area network that interconnects the server 302, the client 306 and the real user monitor 308. Alternatively, the network 304 may be any one or more networks such as, for example, local area network(s), wide area network(s), the internet, wireless network(s), wired network(s), etc.

The client 306 of the illustrated example communicates with the server 302 via the network 304. The example client 306 is a user computer that encrypts data using a public key and sends the data to the server 302 using HTTPS. The system 300 may include more than one client 306. Additionally, the client 306 may communicate with any type of server 302 that provides any type of service. The client 306 may additionally receive data encrypted using a public or private key and may decrypt the data using any type of public or private key.

The real user monitor 308 of the illustrated example obtains communications between the server 302 and the client 306 that are transmitted over the network 304 to monitor the interactions of the server 302 and the network 306. The real user monitor 308 of the illustrated example receives the communications by interacting with a switch in the network 304 that sends copies of communications to the real user monitor 308 without interrupting or interfering with the communications. Accordingly, the real user monitor 308 obtains copies of the communications for analysis and reporting. Alternatively, the real user monitor 308 could obtain the communications in any other manner such as, for example, interfacing with one or more of the server 302 or the client 306, receiving communications broadcast on the network 304, monitoring a firewall in the network 304, working with any number of hubs, routers, and switches, etc.

When the communications encrypted for a private key (e.g., data communications, handshake communications for establishing a symmetric key, etc.) are obtained by the real user monitor 308, the real user monitor 308 obtains the corresponding private key from the encryption key manager 100 or 200. For example, the example real user monitor 308 determines the server 302 to which communications are directed and accesses the private keys stored by the encryption key manager 100 or 200 to determine if a private key for the server 302 has been stored. Accordingly, the real user monitor 308 uses the private key to decrypt the communications and analyze them.

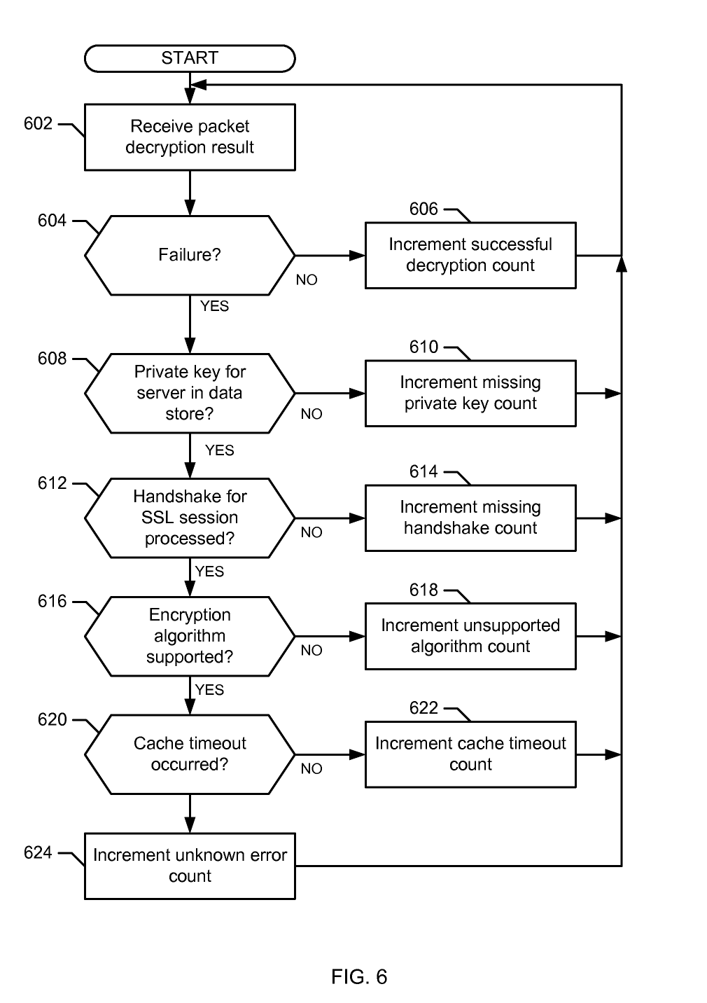

According to the illustrated example, user of the real user monitor 308 (e.g., a network administrator), extracts the private key(s) stored on the server 302 and uploads them to the encryption key manager 100 or 200 to enable the real user monitor 308 to analyze communications encrypted using the public key corresponding to the private key. The decryption monitor 310 monitors the decryption process at the real user monitor 308 to analyze the success of decryption. As described in further detail in conjunction with FIG. 6, the decryption monitor 310 can determine when: decryption is successful, a private key is not available to decrypt a received communication, a communication cannot be decrypted because a handshaking communication between the server 302 and the client 306 has not been received, a communication cannot be decrypted because an unsupported encryption algorithm has been used, a communication was not decrypted because a cache timeout occurred, etc. The real user monitor 308 may additionally or alternatively detect and report any other errors.

While the foregoing describes utilizing the encryption key manager 100 and the encryption key manager 200 in the real user monitor 308 of the example system 300, the encryption key manager 100 and the encryption key manager 200 may alternatively be used in any other system. For example, the encryption key manager 100 and the encryption key manager 200 may be used in any system that utilizes a store of private keys for decrypting communications.

The encryption key manager 100, the encryption key manager 200, and the decryption monitor 310 of the illustrated examples of FIGS. 1-3 are implemented by JAVA instructions executing on a processor system.

While an example manner of implementing the encryption key manager 100 of FIG. 1, the encryption key manager 200 of FIG. 2, and the decryption monitor 310 of FIG. 3 has been illustrated in FIGS. 1-3, one or more of the elements, processes and/or devices illustrated in FIGS. 1-3 may be combined, divided, re-arranged, omitted, eliminated and/or implemented in any other way. Further, the example format detector 102, the example format converter 104, the example user interface 202, the example upload receiver 204, the example format detector 206, the example error detector 208, the example format converter 210, the example data store 212, the decryption monitor 310, and/or, more generally, the example encryption key manager 100 of FIG. 1 and/or the example encryption key manager 200 of FIG. 2 may be implemented by hardware, software, firmware and/or any combination of hardware, software and/or firmware. Thus, for example, any of the example format detector 102, the example format converter 104, the example user interface 202, the example upload receiver 204, the example format detector 206, the example error detector 208, the example format converter 210, the example data store 212, the decryption monitor 310 and/or, more generally, the example encryption key manager 100 of FIG. 1 and/or the example encryption key manager 200 of FIG. 2 could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended apparatus claims are read to cover a purely software and/or firmware implementation, at least one of the example format detector 102, the example format converter 104, the example user interface 202, the example upload receiver 204, the example format detector 206, the example error detector 208, the example format converter 210, the example data store 212, the decryption monitor 310, and/or, more generally, the example encryption key manager 100 of FIG. 1 and/or the example encryption key manager 200 of FIG. 2 are hereby expressly defined to include a computer readable medium such as a memory, DVD, CD, etc. storing the software and/or firmware. Further still, the example encryption key manager 100 of FIG. 1, the example encryption key manager 200 of FIG. 2, and/or the decryption monitor 310 of FIG. 3 may include one or more elements, processes and/or devices in addition to, or instead of, those illustrated in FIGS. 1-3, and/or may include more than one of any or all of the illustrated elements, processes and devices.

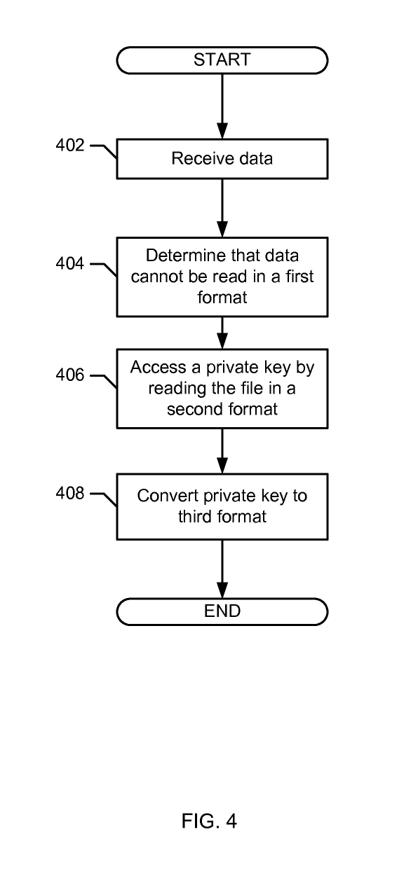

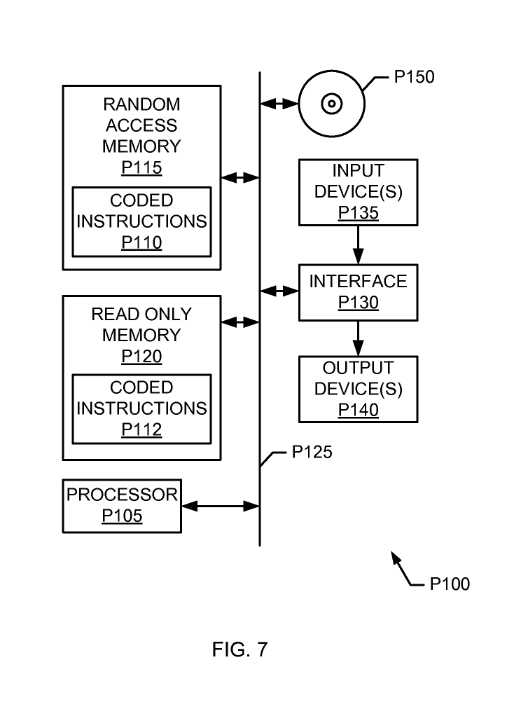

A flowchart representative of example machine readable instructions for implementing the encryption key manager 100 of FIG. 1, the encryption key manager 200 of FIG. 2, and/or the decryption monitor 310 of FIG. 3 are shown in FIGS. 4-6. In this example, the machine readable instructions comprise a program for execution by a processor such as the processor P105 shown in the example computer P100 discussed below in connection with FIG. 7. The program may be embodied in software stored on a computer readable medium such as a CD-ROM, a floppy disk, a hard drive, a digital versatile disk (DVD), or a memory associated with the processor P105, but the entire program and/or parts thereof could alternatively be executed by a device other than the processor P105 and/or embodied in firmware or dedicated hardware. Further, although the example program is described with reference to the flowcharts illustrated in FIG. 4-6, many other methods of implementing the example the encryption key manager 100 of FIG. 1, the example encryption key manager 200 of FIG. 2, and the example decryption monitor 310 of FIG. 3 may alternatively be used. For example, the order of execution of the blocks may be changed, and/or some of the blocks described may be changed, eliminated, or combined.

As mentioned above, the example processes of FIGS. 4-6 may be implemented using coded instructions (e.g., computer readable instructions) stored on a tangible computer readable medium such as a hard disk drive, a flash memory, a read-only memory (ROM), a compact disk (CD), a digital versatile disk (DVD), a cache, a random-access memory (RAM) and/or any other storage media in which information is stored for any duration (e.g., for extended time periods, permanently, brief instances, for temporarily buffering, and/or for caching of the information). As used herein, the term tangible computer readable medium is expressly defined to include any type of computer readable storage and to exclude propagating signals. Additionally or alternatively, the example processes of FIGS. 4-6 may be implemented using coded instructions (e.g., computer readable instructions) stored on a non-transitory computer readable medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

FIG. 4 is a flowchart representative of example machine readable instructions to implement encryption key manager 100 of FIG. 1. The illustrated example of FIG. 4 begins when the format detector 102 receives data from a user (block 402). According to the illustrated example, the data is a file that includes a private key. The format detector 102 then determines that the data cannot be read in a first format (block 404). According to the illustrated example, the first format is a key file format. In response to determining that the data cannot be read in the first format, the format detector 102 accesses the private key in the data by reading the file in a second format (block 406). According to the illustrated example, the second format is a key file format different from the first format. Because the file is in the second format, the format detector 102 is able to read to file according to the second format and, therefore, determines that the file is in the second format. After accessing the file by reading the file in the second format (block 406), the format converter 104 converts the private key to a third format (block 408). According to the illustrated example, the third format is the OpenSSL PEM format. Therefore, according to the illustrated example, private keys are automatically detected as being encoded in the second format without the user specifying the format. The process of FIG. 4 can be expanded to check more than two formats. Furthermore, when the file is in the first format, the format detector 102 would be able to access the file in the first format and control may proceed from block 404 to block 408.

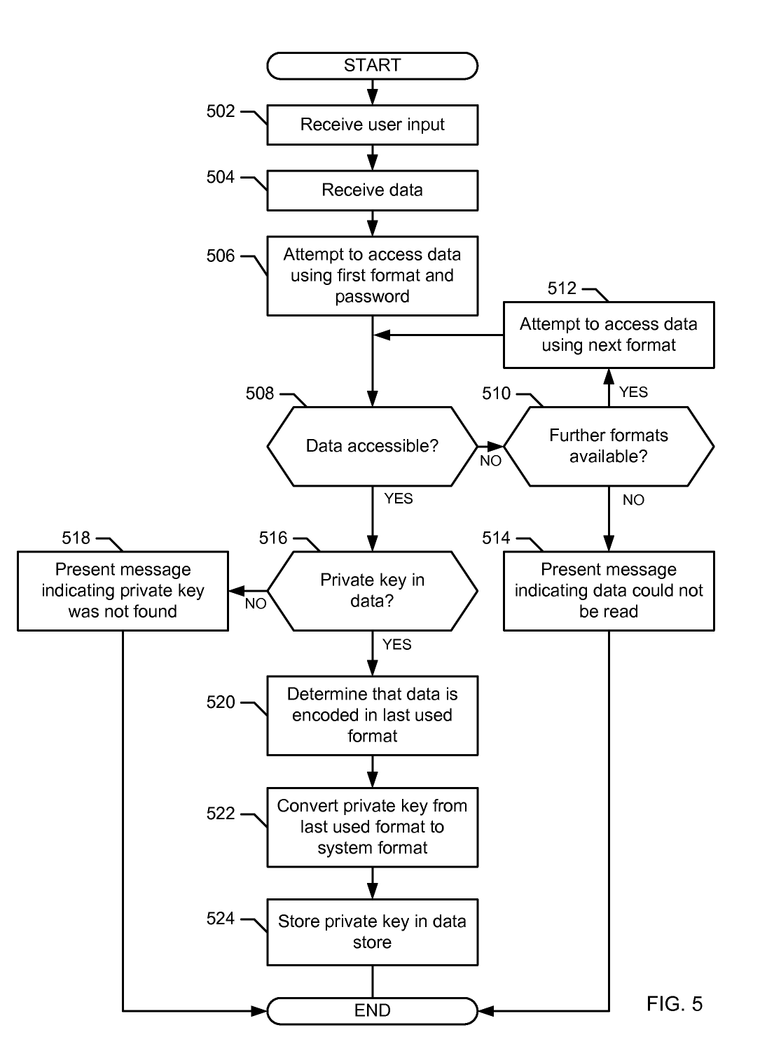

FIG. 5 is a flowchart representative of example machine readable instructions to implement the encryption key manager 100 of FIG. 1. The illustrated example of FIG. 5 begins when the user interface receives a user input (block 502). According to the illustrated example, the user interface 202 receives an identification of the location at which a file containing a private key is stored and receives a password for the private key. The upload receiver 204 then receives data identified by the user input (block 504). According to the illustrated example, the data is the file that includes the private key. The format detector 206 then attempts to access the data using a first format and a received password (when a password is used) (block 506). According to the illustrated example, the format detector 206 includes the ability to read several formats for the file. The format detector 206 then determines if the data is accessible using the first format (block 508). When the data is not accessible using the first format, the format detector 206 determines if there are further formats that have not been used to attempt to access the data (block 510). When there are further formats, the format detector 206 attempts to access the data using the next available format (block 512). When there are no further formats, the format detector 206 and/or the error detector 208 present a message on the user interface 202 indicating that the data could not be read because the format is unrecognized (block 514). The instructions of FIG. 5 then terminate.

Returning to block 508, when the format detector 206 determines that the data is accessible using a particular format, the format detector 206 determines if a private key is in the data (block 516). The format detector 206 of the illustrated example determines if a private key is present using one or both of enumeration and searching. An example enumeration procedure iterates over the contents of the file and checks the type of each entity to determine if the entity is a private key. An example search procedure searches the file for a private key and can use a name or alias for the private key. The example format detector 206 uses enumeration and search procedures available in JAVA Security application programming interfaces (APIs). In particular, the format detector 206 of the illustrated example uses APIs from the Legion of the Bouncy Castle. Alternatively, any process and/or API for detecting the presence of a private key may be used. When a private key is not detected in the data, the format detector 206 and/or the error detector 208 present a message on the user interface 202 indicating that a private key was not found (block 518). The instructions of FIG. 5 then terminate.

When a private key is detected in the data (block 518), the format detector 206 determines that the data is encoded in the format used to access the data (i.e., the last used format) (block 520). The format converter 210 then converts the private key to a system format (block 522). For example, the format detector 206 and/or the format converter 210 may extract the private key from the data as a private key object and convert the private key object to an OpenSSL PEM format. Alternatively, any other conversion process and format may be used. The format converter 210 then stores the converted private key in the data store 212 (block 524). The instructions of FIG. 5 then terminate.

While the instructions of FIG. 4 are described as implementing the encryption key manager 100 of FIG. 1 and the instructions of FIG. 5 are described as implementing the encryption key manager 200 of FIG. 2 procedures described in each of FIGS. 4 and 5 may be performed by any of the components of the encryption key manager 100 and the encryption key manager 200.

FIG. 6 is a flowchart representative of example machine readable instructions to implement the decryption monitor 310 of FIG. 3. The illustrated example begins when the decryption monitor 310 receives a result of decryption of a communications packet from the real user monitor 308 (block 310). For example, when the real user monitor 308 receives a communication sent from the client 306 to the server 302 that is encrypted using a public key associated with a private key, the real user monitor 308 will attempt to retrieve a public key from a data store associated with the encryption key manager 100 and/or the encryption key manager 200 and to decrypt the communication using the private key. A result of the decryption is sent to the decryption monitor 310.

The decryption monitor 310 determines if the result indicates that the decryption was successful. When the decryption was successful, the decryption monitor 310 increments a successful decryption count (block 606). The successful decryption count of the illustrated example is a variable stored in memory that indicates the number of decryption procedures that were successful. The instructions then return to block 602 to await the next decryption.

Returning to block 604, when the result indicates a failure, the decryption monitor determines if a private key for the destination of the communication (e.g., the destination server) is stored in the encryption key manager 100 and/or the encryption key manager 200. When a private key is not stored in the encryption key manager 100 and/or the encryption key manager 200, the decryption monitor 310 increments a missing private key count (block 610). The missing private key count of the illustrated example is a variable stored in memory that indicates the number of decryption procedures that failed due to the encryption key manager not storing a private key for decrypting the communication. For example, a missing private key error may occur when a network administrator has not added a private key for the destination of the communication (e.g., a server for which the communication is directed) or the keys for a destination have changed. The instructions then return to block 602 to await the next decryption.

When a private key for the destination server is in the data store (block 608), the decryption monitor 310 determines if a handshake for the SSL session has been processed by the real user monitor 308 (block 612). The SSL handshake is performed at the start of a secure communication session to establish the parameters of the secure communication. During the handshake, the client provides the server with a random key to use for secure communications. If this communication is not processed by the real user monitor 308, the real user monitor 308 will not know the key used for the particular communication session and will be unable to decrypt communications for the session. When the handshake has not been processed by the real user monitor 308 (block 308), the decryption monitor 310 increments a missing handshake count (block 614). The missing handshake count of the illustrated example is a variable stored in memory that indicates the number of decryption procedures that failed due to missing the handshake communication(s). The instructions then return to block 602 to await the next decryption.

When a handshake for the SSL session has been processed (block 612), the decryption monitor 310 determines if the encryption algorithm used for the communication is supported (block 616). For example, the real user monitor 308 of the illustrated example does not support Diffie-Hellman (DH) key exchange. Accordingly, when a communication session is encrypted suing DH key exchange, the real user monitor 308 will be unable to decrypt and analyze the communications. When the decryption monitor 310 determines that the encryption algorithm used for the communication is not supported (block 616), the decryption monitor 310 increments an unsupported algorithm count (block 618). The unsupported algorithm count of the illustrated example is a variable stored in memory that indicates the number of decryption procedures that failed due to an unsupported encryption algorithm. The instructions then return to block 602 to await the next decryption.

When the encryption algorithm is supported (block 616), the decryption monitor 310 determines if a cache timeout has occurred (block 620). According to the illustrated example, when a handshake to establish a symmetric key for a communication session has previously been performed, a short handshake can be used to re-open the communication session using a previously agreed upon symmetric key. When the real user monitor 308 receives a communication for a short handshake, but has previously not received a long handshake in which the symmetric key has been established, the real user monitor 308 caches the communication for later decryption when another long handshake is received. According to the illustrated example, a cache timeout occurs when a long handshake with the symmetric key is not received before the timeout period expires. A cache timeout may occur due to communication problems or issues that delay communications or prevent some communications from being received and processed. When the decryption monitor 310 determines that a cache timeout has occurred (block 620), the decryption monitor 310 increments a cache timeout count (block 622). The cache timeout count of the illustrated example is a variable stored in memory that indicates the number of decryption procedures that failed due to a cache timeout. The instructions then return to block 602 to await the next decryption.

When the decryption monitor 310 determines that a cache timeout has not occurred (block 620), the decryption monitor 310 increments an unknown error count (block 624). The unknown error count of the illustrated example is a variable that indicates the number of decryption procedures that failed due to an unknown error. Alternatively, the decryption monitor 310 may ignore errors that are not of a known type. The decryption monitor 310 may also include recognition for other types of decryption errors. After incrementing the unknown error count, the instructions then return to block 602 to await the next decryption.

The counts described in blocks 602, 606, 610, 614, 618, and 622 are displayed to users on a user interface (e.g., the user interface 202 of FIG. 2) to provide feedback regarding the decryption procedures. Accordingly, a user can review the counts to determine how often and for what reason, decryption errors occur. The counts may be displayed directly or may be displayed as percentages indicating the percentage of the time that each error or successful decryption occurs.

While the instructions of FIG. 6 analyze decryption results as they occur in the real user monitor 308, the results of decryptions procedures may be analyzed at a later time. For example, the decryption monitor 308 may analyze a log file or other stored information regarding decryption procedures to determine the outcome of decryption procedures.

FIG. 7 is a schematic diagram of an example processor platform P100 that may be used and/or programmed to execute the interactions and/or the example machine readable instructions of FIGS. 4-6 to implement the example format detector 102, the example format converter 104, the example user interface 202, the example upload receiver 204, the example format detector 206, the example error detector 208, the example format converter 210, the example data store 212, the decryption monitor 310, and/or, more generally, the example encryption key manager 100 of FIG. 1 and/or the example encryption key manager 200 of FIG. 2. One or more general-purpose processors, processor cores, microcontrollers, etc may be used to implement the processor platform P100.

The processor platform P100 of FIG. 7 includes at least one programmable processor P105. The processor P105 may implement, for example, the example format detector 102, the example format converter 104, the example user interface 202, the example upload receiver 204, the example format detector 206, the example error detector 208, the example format converter 210, the example data store 212, the decryption monitor 310, and/or, more generally, the example encryption key manager 100 of FIG. 1 and/or the example encryption key manager 200 of FIG. 2. The processor P105 executes coded instructions P110 and/or P112 present in main memory (i.e., a computer readable storage medium) of the processor P105 (e.g., within a RAM P115 and/or a ROM P120) and/or stored in the tangible computer-readable storage medium P150. The processor P105 may be any type of processing unit, such as a processor core, a processor and/or a microcontroller. The processor P105 may execute, among other things, the example interactions and/or the example machine-accessible instructions of FIGS. 4-6 to manage private keys, as described herein. Thus, the coded instructions P110, P112 may include the instructions of FIGS. 4-6.

The processor P105 is in communication with the main memory (including a ROM P120 and/or the RAM P115) via a bus P125. The RAM P115 may be implemented by dynamic random access memory (DRAM), synchronous dynamic random access memory (SDRAM), and/or any other type of RAM device, and ROM may be implemented by flash memory and/or any other desired type of memory device. The tangible computer-readable memory P150 may be any type of tangible computer-readable medium such as, for example, compact disk (CD), a CD-ROM, a floppy disk, a hard drive, a digital versatile disk (DVD), and/or a memory associated with the processor P105. Access to the memory P115, the memory P120, and/or the tangible computer-medium P150 may be controlled by a memory controller.

The processor platform P100 also includes an interface circuit P130. Any type of interface standard, such as an external memory interface, serial port, general-purpose input/output, etc, may implement the interface circuit P130. One or more input devices P135 and one or more output devices P140 are connected to the interface circuit P130.

From the foregoing, it will appreciate that the above disclosed methods, apparatus and articles of manufacture enable a user of a system that utilizes private keys to upload private keys to the system without the user specifying the format of the private keys. Accordingly, a user does not need to know the format of the private keys. For example, the user can export private keys from a server and provide those private keys to the system to enable the system to use the private keys. For example, the system can use the private keys to decrypt communications associated with the server. Furthermore, the methods, apparatus and articles of manufacture provide information about a decryption process that utilizes the private keys uploaded to the system.

Although certain example methods, apparatus and articles of manufacture have been described herein, the scope of coverage of this disclosure is not limited thereto. On the contrary, this patent covers all methods, apparatus and articles of manufacture fairly falling within the scope of the claims of this patent either literally or under the doctrine of equivalents.

What is claimed is:

1. A method to manage encryption keys, the method comprising:
obtaining data including a private key;
determining that the data cannot be read according to a first format by attempting to read the data in the first format;
in response to determining that the data cannot be read according to the first format, accessing the private key by reading the data according to a second format different from the first format; and
converting the data from the second format to a third format.

2. A method as defined in claim 1, wherein the third format is the first format.

3. A method as defined in claim 1, further comprising:
receiving a second data;
determining that the second data does not include a private key; and
in response to determining that the second data does not include a private key, presenting a message indicating that the second data does not include a private key.

4. A method as defined in claim 3, wherein the second data is a file containing a digital certificate.

5. A method as defined in claim 1, further comprising storing the private key in the third format.

6. A method as defined in claim 1, further comprising storing the converted file in a data store.

7. An apparatus comprising:
a format detector to:
attempt to read a private key from a file according to a first file format;
determine that the private key cannot be read in the first file format;
after attempting to read the private key from the file according to the first file format, attempt to read the private key from the file according to a second file format; and
determine that the file is encoded according to the second format based on attempting to read the private key from the file according to the second file format; and
a format converter to convert the file from the first file format to a third file format.

8. An apparatus as defined in claim 7, further comprising an upload receiver to receive the file.

9. An apparatus as defined in claim 7, wherein the format converter is further to store the file in a data store.

10. An apparatus as defined in claim 9, further comprising a real user monitor to:
receive an encrypted communication directed from a first computing device to a second computing device;
access the data store to retrieve the private key; and
decrypt the encrypted communication using the private key.

11. An apparatus as defined in claim 10, wherein the real user monitor is associated with a business service management system.

12. An apparatus as defined in claim 10, further comprising a decryption monitor to:
determine that decrypting the encrypted communication using the private key resulted in failure;
in response to the failure, determine that a private key for the second computing device is not stored in the data store; and
in response to determining that the private key for the second computing device is not stored in the data store, indicating that the decryption failed because the private key is missing.

13. A tangible computer readable medium storing instructions that, when executed, cause a machine to:
receive a file containing a private key;
convert the private key from a first format to a second format;
store the private key in a data store;
attempt to decrypt communications received from a network using the stored private key; and
determine an error rate based on the attempt to decrypt communications.

14. A tangible computer readable medium as defined in claim 13, wherein the instructions cause the machine to determine an error rate by determining a percentage of decryptions that result in failure.

15. A tangible computer readable medium as defined in claim 14, wherein the error rate is at least one of a missing private key error rate, a missing handshake error rate, an unsupported encryption algorithm error rate, and a cache timeout error rate.
